(19) United States
(12) Patent Application Publication
(10) Pub. No.: US 2024/0317451 A1
(43) Pub. Date: Sep. 26, 2024

(54) BOTTLE

(71) Applicant: Diageo Great Britain Limited, London (GB)

(72) Inventors: Paul Clifford Smith, Cambridgeshire (GB); Barry John Hawkes, Berkshire (GB); Guy Nicolas Peter Harrison, Berkshire (GB)

(21) Appl. No.: 18/385,491

(22) PCT Filed: May 4, 2022
(86) PCT No.: PCT/GB2022/051124

§ 371 Date: Oct. 31, 2023

(30) Foreign Application Priority Data
May 7, 2021 (GB) 2106542.0

(51) Int. Cl. B65D 3/10; B65D 3/26

(52) U.S. Cl. CPC B65D 3/10; B65D 3/268

(57) ABSTRACT

A bottle featuring a tubular body portion (13) formed in one piece by a spiral wound tube manufacturing process. A shoulder portion (11, 15) is joined to a first end of the body and a base portion (14) is joined to a second, opposite, end of the body potion. The shoulder portion is comprised of an inner shoulder (15) and an outer shoulder (11) that provide mutual support for a neck (12) and to provide a structurally familiar beverage package shape such as a flask or bottle. The neck may comprise a frustum shaped end (26) that engages with a mating surface (23) of the inner shoulder (15).

### TECHNICAL FIELD

The present invention relates to a bottle formed substantially from paper so that the use of plastics is minimised. The bottle is a form of consumer packaging useful for holding liquids, e.g. beverages.

### BACKGROUND TO THE INVENTION

It is desirable to reduce plastics use in consumable items, particularly packaging. Trays and simple shapes are commonly made from paper pulp, but more complex objects and those required to hold liquids are more difficult to engineer.

Bottles made from a substantive paper construction have been proposed. For example, U.S. Pat. No. 10,526,120 describes strategies for fitting a shoulder piece to a main body. The shoulder and body of the bottle are made from thermoformed pulp but cannot be made in one piece due to limitations of the manufacturing process. A neck portion made from bioplastics is attached to the shoulder which is subsequently mated and adhered to the main body. The purpose of the bottle is that it is biodegradable by virtue of substantive paper construction and bioplastic neck.

A further example of a paper-based bottle is known from US2020407100, featuring a spiral wound paper body. The shoulder construction is relatively rudimentary, with limited strength and aesthetic considerations.

### SUMMARY OF THE INVENTION

The present invention seeks to provide a bottle made predominantly of paper that is an improvement over or at least an alternative to known methods of manufacture. Ideally, the paper content and construction is such that it is sufficient to meet current and future requirements for recycling in the paper recycling stream.

A technology for application in the construction of a body for a paper-based bottle, as identified by the present inventors, involves the use of sheet paper wound spirally to form tubes. Such a technique has been known for decades in the production of protective cylinders (e.g. for posters/artwork), as a core for rolled products (e.g. adhesive tape or wrapping paper) and some packaging solutions. Indeed, prior art example US2004052987 proposes a can structure where the side wall is spiral wound paper. However, for use as a bottle, it will be necessary to fit a suitable shoulder/neck and base. Furthermore, the entire container must be liquid-tight in order to be suitable for storage of beverages and other liquids.

In a broad aspect implementing the invention a bottle is defined according to claim 1. A method of manufacture according to the invention is defined at claim 22. Other useful features are outlined in dependent claims.

The invention is most broadly considered construction of a bottle from three primary components, namely: a main tubular body formed in one piece by a manufacturing process such as that used to make spiral wound tubes or cores; a shoulder (which may incorporate a neck or provision for a neck fitment through it); and a base fitment. The three components fit together to form a substantive bottle shape. A “bottle” shape is one that has a shoulder transitioning to a neck portion narrower (typically of small diameter) than the substantive body which provides most of the volume for storage of a liquid. The base provides a surface upon which the bottle can stand upright. A spiral wound paper manufacturing process is able to produce a relatively strong and rigid (e.g. generally non-compressible laterally and extremely strong for vertical stacking) body, capable of a premium finish required by high-value liquids. The thickness of the body wall may be selected (e.g. 2.5 mm) according to how many winds of paper are performed during manufacture. A spiral construction is distinct from a pulp body which will necessarily have a thinner wall (e.g. 1 mm) more susceptible to lateral compression and is challenging to mould in an elongate shape. Furthermore, the paper from which the spiral wound body is formed may come from a recycled source whereas, in general, a pulp body is more likely produced from virgin pulp.

The shoulder, neck and/or base part may be formed from components in a suitable process, most preferably also a pulp-based method such as compression moulding. At present it is expected that, if it is not possible to form from paper, at least the neck part may need to be moulded from a commonly available plastic such as PET, HDPE or PP that exhibits a satisfactory torque strength for a screw thread. The main example of shoulder constructions described herein is comprised of a two-part construction, namely an inner shoulder and an outer (or over-) shoulder. The over shoulder covers/hides connecting edges of the inner shoulder with the main body.

However, it is noteworthy that the over shoulder is at least partly for aesthetic considerations and is not essential for forming a closure on the body to contain contents. Therefore, the robust “inner shoulder”, thermoformed from pulp, may stand alone as a novel construction, in combination with a body, back and neck, in the present context.

In one form a neck fitment may be provided with a snap-on feature, heat sealed to a shoulder portion. For example, a snap-on ring is snap-fitted onto the neck fitment to sandwich a surface of the shoulder between itself and a flange of an end of the neck fitment proximate the main body. The neck fitment may alternatively be threaded or glued to the shoulder.

The substantive shoulder piece may be heat sealed to the main body. The over shoulder may be decorative and/or provide enhanced structural support to the neck and inner shoulder heat sealed to the body. Preferably the over shoulder is held tightly to the main/inner shoulder piece, providing strength to prevent a neck fitment being pushed through under a top-load. Alternatively, components could be sonic welded or screwed onto the fitment. In further forms a spacer insert may separate the shoulder piece (i.e. the piece that serves as an end portion for the main body) and the exterior “over-shoulder”.

In one form, internal surfaces of various components are coated or laminated with a heat sealable layer, at least in a contact/seam area. Lamination is the presently preferred form, but spray coating may be optimised for use with the invention depending on the field of use. In further forms an internal bag may be provided.

As mentioned, for fitment of a neck to a shoulder, either a neck insert is moulded into/onto the shoulder or the neck may be comprised of two components: a main section and an internal section. The pieces may be screwed/threaded, welded, glued or snap-fitted together, sandwiching the shoulder therebetween.

The main body portion may be a tube of any cross-section, e.g. circular (most common bottle shape), rectangular (a flask shape), “sqround” (generally square but with rounded corners) or any other closed geometry, i.e. in principle tubes constructed from spirally wound layers of paper may take any closed cross-section form. An internal layer may be a barrier layer against egress of liquid. Decorative/identification material may be printed directly on the outer layer or incorporated into a sleeve that surrounds the main body, potentially heat shrunk and overlapping the shoulder and base.

In a particular form, the shoulder portion is an end/lid made from thermoformed pulp. It may include a central opening to receive the neck fitment. Likewise, the base portion may be an end made from formed paper/card or pulp to close off the open tube of the main body.

In one form the neck is a recyclable or at least separable material such as PET, Polyethylene (HDPE), PP threaded fitment that provides a pouring spout and thread for fixing a cap. The neck portion may be alternatively adapted for other closure types, such as a cork or recloseable spout (e.g. a “sipper bottle”).

In one form the body and base may be curled/seamed together. In one form the body and shoulder may butt together at edges of the same cross-section where a separate ring component is glued to the inside of both components, preferably prior to joining of the body and base which finally completes/closes the bottle shape.

While a seam may be visible, the shoulder and main body may have a smooth/continuous transition therebetween on the external surface of the package as a whole, to achieve a conventional bottle or flask shape. A sleeve/label layer may be applied to cover over any otherwise visible joins between the shoulder and tubular main body.

### BRIEF DESCRIPTION OF THE DRAWINGS

FIG. 1 illustrates a perspective exterior view of a bottle construction based on the principles of the invention;

FIGS. 2 and 3 illustrate front and side section views respectively of a of a bottle according to FIG. 1;

FIG. 4 illustrates an exploded view, from above, of structural components for the bottle;

FIG. 5 illustrates a series of side elevation section views of an assembly method for a neck portion to a shoulder;

FIGS. 6 and 7 illustrate exploded component perspective views, from above and below respectively, of a further embodiment of the invention; and

FIG. 8 illustrates an exploded component perspective overviews of a “sqround” embodiment.

### DETAILED DESCRIPTION OF THE INVENTION

The following description presents exemplary embodiments and, together with the drawings, serves to explain principles of the invention. However, the scope of the invention is not intended to be limited to the precise details of the embodiments or exact adherence with all steps, since variations will be apparent to a skilled person and are deemed also to be covered by the description. Terms for components used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” are used for convenience of explanation usually with reference to the illustrations and are not intended to be ultimately limiting if an equivalent function can be achieved with an alternative dimension and/or direction. The term “tubular” herein generally refers to an elongate/extruded-type hollow shape, although a tube may have a greater diameter than its length. A tube may be circular in cross section or any other closed shape.

The description herein refers to embodiments with particular combinations of manufacturing steps or features, however, it is envisaged that further combinations and cross-combinations of compatible steps or features between embodiments will be possible. Indeed, isolated features may function independently as an invention from other features and not necessarily require implementation as a complete combination.

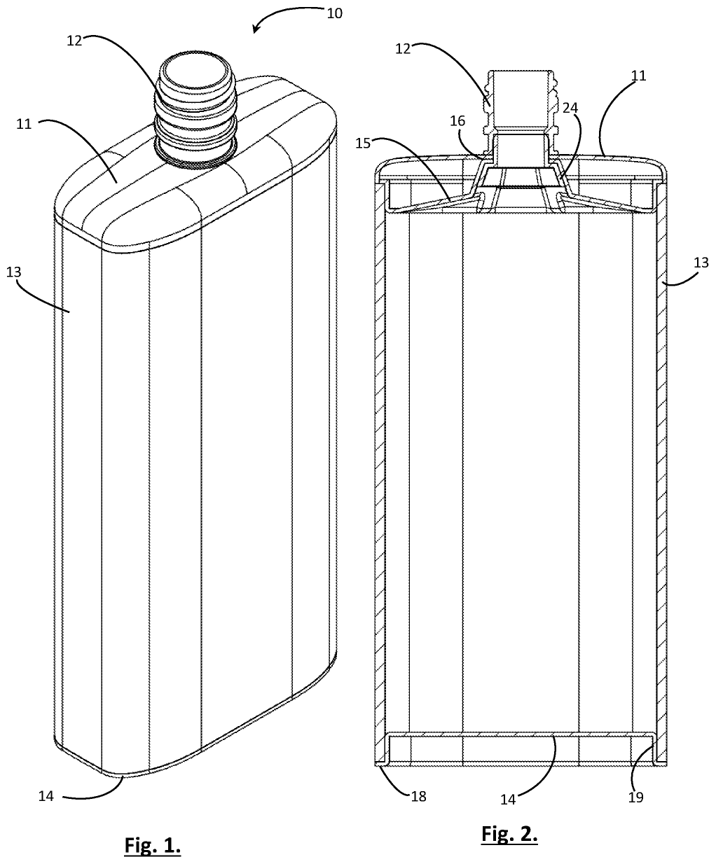

FIGS. 1 to 4 illustrate an overview of a flask-shaped bottle. Namely, a bottle 10 comprising a shoulder portion 11, including a neck 12, joined to a tubular main body 13. The main body 13 has been formed by a manufacturing process where a continuous sheet of paper is spirally wound on a rotating core with adhesive and/or compressive force. In this way a spiral would body has exceptional strength, both against lateral compression/squeezing the bottle sidewalls, and vertically for stacking, compared to, say, a wall formed from compressed/thermoformed pulp.

A base portion 14 provides an end closure against body 13 and a surface upon which the bottle can stand upright.

A broadside elevation cross section of the flask is shown by FIG. 2. Shoulder 11 is formed, preferably from pulp in a compression moulding process, in a structure that includes a an edge, for providing a surface to heat seal against body 13. Neck 12 may be co-moulded into shoulder 11 or, as illustrated, formed from several components joined with over shoulder 11 and an internal shoulder than provides structural strength.

Base 14 may include a trench or channel-like mating feature with body 13 but since, in use, the base is mostly hidden from view (i.e. minimal aesthetic considerations) a ground contacting peripheral flange 18 is quite sufficient to provide a stable support so that the bottle can stand upright. It will be apparent that an upstanding wall 19 of base 14 provides adequate surface for a heating tool to be clamped over said wall and the adjoining wall of body 13.

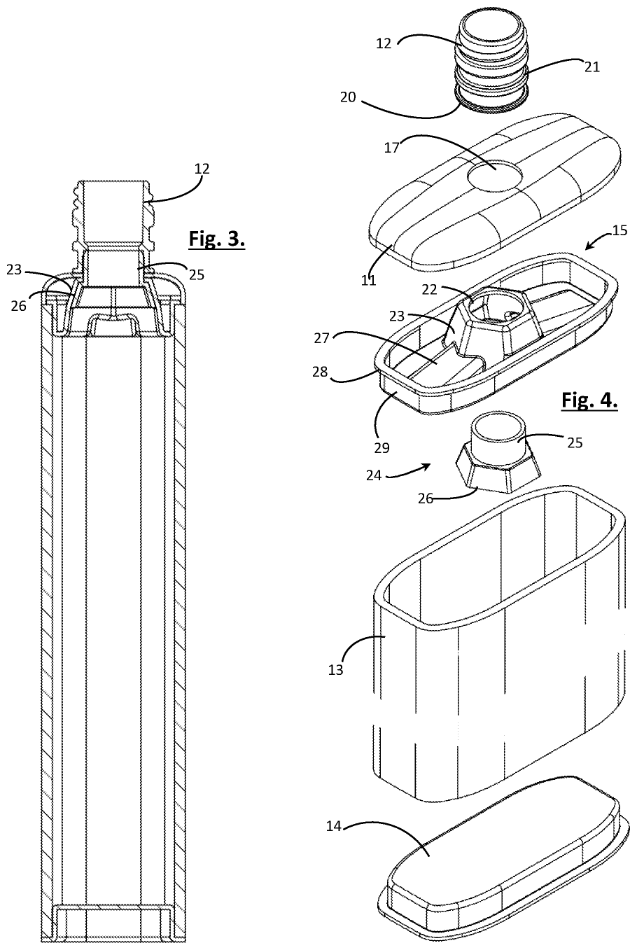

Further internal detail of the shoulder arrangement illustrated by FIG. 2 is shown by FIGS. 3 and 4. Particularly, shoulder 11 is an over-shoulder moulding that provides a smoother curved corner appearance, to be fitted over an inner shoulder portion 15 that provides the main structural support.

As illustrated by FIGS. 2 and 3, an air gap is apparent between substantive surfaces 11 and 15, however in one form, an underside of surface 11 may be in contact with (i.e. sandwiched against) at least part of inner shoulder 15, e.g. at a contact point 16.

Referring to FIG. 4, which best illustrates how component parts of an embodiment of the bottle assembly fit together, the substantive flask volume for containing a liquid is defined by the inner shoulder portion 15, configured for joining to the tubular main body 13 and enclosed by base 14. Body 13 is shown in broken lines to represent any elongate continuous tubular shape. The base portion 14 provides an end closure against body 13 and a surface upon which the bottle can stand upright.

The shoulder structure, as mentioned above, is comprised of inner shoulder 15 for improved structural rigidity and outer shoulder 11, wherein an outer neck fitment 12 is abutted against an outer opening 17 in the outer shoulder 11 by a proximal end flange 20. A mid-neck located annular flange 21 provides a ridge for receiving an anti-tamper security feature of a twist cap closure or the like. An inner opening 22, at a frustum shaped support 23 extending centrally from the inner shoulder 15 is abutted against and aligned with the other (inner) side of opening 17 at contact surface 16 (FIG. 2). The first/outer neck fitment 12 is secured by coupling with a second, internal, neck fitment 24 comprised of a tubular element 25 and a frustum shaped base 26 which generally flares from the tubular wall 25.

Section views FIGS. 2 and 3 show that the tubular element 25 of the second neck fitment 24 is received by an internal bore of the first neck fitment 12, while the tapered frustum surfaces 26 and 23 engage and form an abutment and anti-twist feature. In other words, the mating, generally hexagonal base frusto-pyramid, shapes engage and provide structural support that prevents the second neck fitment 24 from being twisted relative to a longitudinal axis. The first neck fitment 12 may be in keyed engagement with the second neck fitment 24 and/or, in any event, may be glued or sonically welded therewith.

One or more ribs 27 (emulating a collar bone) extending radially from frustum support 23 provide additional rigidity to inner shoulder 15. It will be apparent from the combined configuration that the over shoulder 11 (primarily serving an aesthetic function) provides structural strength to buttress against a rim 28 of the inner shoulder 15, such that the components may be formed from pulp, rendering the entire product substantially recyclable. Rim 28 provides a flange that can be adhered/welded against a top opening edge of body 13. An upstanding outwardly facing wall 29 supporting rim 28, forming an overall cup shape to inner shoulder 15, also provides a surface for bonding/joining to main spiral formed body 13.

The structure of shoulder 15 may be considered a standalone divisible invention for combination with a body 13 and neck 12 to comprise a bottle; i.e. a cup shaped end for receipt into and adherence to the internal walls of an open end of a body 13, optionally including supporting ribs radiating from a twist resistant neck support element.

In alternate forms the neck construction may include an additional spacer or wall layer. If manufacturing processes allow, an upstanding neck portion may be formed in one piece with the inner shoulder. Likewise, an upstanding neck may be formed with the outer shoulder. In this way the neck of the inner shoulder may partially engage into the neck of the outer shoulder to bond the inner and outer shoulders together. Further internal ribs may engage to provide contact (e.g. for bonding) surfaces between components.

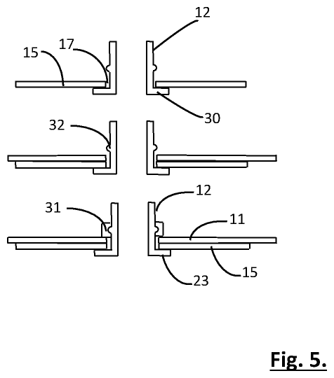

Alternative forms of neck are illustrated according to FIG. 5, wherein a neck moulding 12, e.g. of common plastics, may include a flange 30 at an end proximate body 13 that performs an abutment feature when neck 12 is inserted through an opening 17 in the surface of a portion 15. Flange 30 may be heat sealed or glued to shoulder 15 in this example or alternatively secured by a physical component such as a securing ring 31 that snap fits onto an annular ridge 32 extending peripherally around neck 12. According to the lowermost section illustration of FIG. 5, shoulder 15 and decorative outer layer 11 are sandwiched together between flange 30 and ring 31.

Neck 12 may include a screw thread for a cap or other closure means such as a cork or self-closeable aperture.

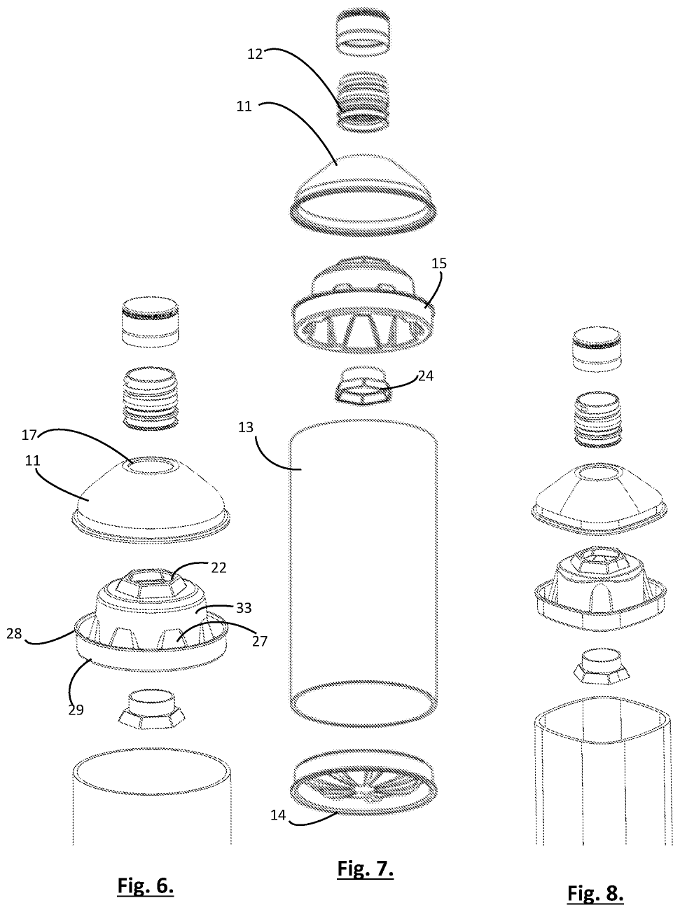

Two further embodiments of a bottle according to the invention are shown by FIGS. 6 to 8, namely a cylindrical and “sqround” body formation respectively. The same reference numerals are used to indicate equivalent structural features, e.g. an upper shoulder 11, neck 12, body 13, base 14 and inner shoulder 15 with rim 28 and upstanding contact wall 29 for adherence to inner walls of body 13.

Neck 12, as above, is comprised of an external tubular element (for receiving a cap) and an inner element 24 that is configured to pass through an opening 17/22 in the inner 11 and/or outer shoulder 15.

Of particular note in the embodiment illustrated by FIGS. 6 and 7 is the protruding nature of the inner structure of shoulder 15 to mate with a corresponding annular receiving surface of over shoulder 11. In this example, radial ribs 27 about a central column 33 serve as mutual locating elements and rigidity enhancements when received into the over shoulder 11. In some forms a substantive surface of inner and outer shoulder ribs may be sandwiched together to form a particularly robust/reinforced shoulder formation.

The bottle of the invention is preferably rendered internally liquid resistant, i.e. so the container is suitable for filling with beverage. A protective layer may be sprayed onto an internal surface, e.g. a spray lance through neck, or a layer may be integrated with the paper material use for each component. Alternatively, a collapsible bag may be housed within body 13 and sealed with neck 12. Such a bag (and associated common plastic neck fitment) is preferably removable during a separation process for recycling.

The invention can be summarised as a bottle making process and associated product. The bottle comprises a tubular body portion formed in one piece, e.g. by a spiral wound tube manufacturing process. The main body cross section may be chosen from a variety of closed shapes; e.g. circle, square, rectangle, triangle. Indeed, any multi sided or curved shape. A two-piece reinforcing shoulder construction is joined to a first end of the body portion and a base portion is joined to a second, opposite, end of the body portion. The two-piece shoulder is comprised of an inner shoulder and an outer shoulder that provide mutual support for a neck and to provide a structurally familiar beverage package shape such as a flask or bottle. The neck may comprise a flared end, e.g. of frustum shape, that engages with a mating surface of the inner shoulder. Reinforcing elements, such as ribs, may be provided on either or both the inner and outer shoulder that optionally mate together for further reinforcement.

A separable invention from the present disclosure can be considered a pulp formed shoulder structure according to “inner shoulder 15” alone. In other words, a cup-like shoulder construction to nestle into and against a tubular main body wall, comprised of a peripheral flange/rim 28 for bonding/joining to a top opening edge of a main body made from paper, an upstanding outwardly facing wall 29 supporting rim 28, for bonding to an internal wall of a main body (13). The shoulder may include supporting ribs radiating from a central neck supporting portion, e.g. formed in a frusto-conical shape for coupling with a complimentary portion of a neck piece. A frusto-conical or equivalent non-circular mating shape provides increased torque and top-load strength for the neck.

1. A bottle, comprising:
a tubular body portion;
a shoulder portion joined at a first open end of the body potion; and
a base portion joined at a second open end of the body portion;
wherein the shoulder portion is comprised of a two-part construction, namely an inner shoulder joined to the body portion and an outer shoulder joined to the inner shoulder and/or body.

2. The bottle of claim 1, wherein the tubular body portion, inner shoulder, outer shoulder and/or the base portion are formed by a pulp-based method or formed in one piece by a spiral wound tube manufacturing process.

3. The bottle of claim 2, wherein the pulp-based method of forming is compression moulding.

4. The bottle of claim 1, further comprising a neck portion configured for receiving a closure.

5. The bottle of claim 4, wherein the neck portion is integrated in one piece with the inner shoulder or outer shoulder.

6. The bottle of claim 4, wherein the neck portion is a separate piece, formed from compression moulded pulp, PET, PP or Polyethylene, attached to the shoulder portion.

7. The bottle of claim 6, wherein the neck portion includes a tubular body and a flange at one end of the tubular body; and the shoulder portion includes an opening for receiving the tubular body of the neck therethrough, while the flange abuts the shoulder portion around the opening.

8. The bottle of claim 7, wherein the tubular body of the neck portion includes a surface feature for receipt by the mating feature of a ring piece configured for surrounding the neck portion; such that the shoulder portion is sandwiched between the flange and the ring piece.

9. The bottle of claim 8, wherein the surface feature is either an annular ridge or a thread.

10. The bottle of claim 4, wherein the neck portion is comprised of at least one neck fitment having a tubular portion and a flared portion for engagement with a mating portion of the inner shoulder.

11. The bottle of claim 10, further comprising an outer neck fitment for receiving the tubular portion.

12. The bottle of claim 10, wherein the flared portion and mating portion are frustum shaped.

13. The bottle of claim 1, wherein the inner and/or outer shoulder further comprise reinforcement elements, such as ribs.

14. The bottle of claim 13, wherein the inner and outer shoulder comprise mutual reinforcement elements that mate together when the two-part construction is joined.

15. The bottle of claim 1, wherein the inner shoulder portion and/or base portion comprises a channel and/or flange configured to be heat sealed, glued or welded to the tubular body portion.

16. (canceled)

17. The bottle of claim 1, including an internal protective coating or lamination to render the bottle resistant to liquid egress.

18. The bottle of claim 1, including an internal bag to render the bottle resistant to liquid egress.

19. The bottle of claim 1, including an outer sleeve for covering at least a part of the tubular body portion.

20. The bottle of claim 19, wherein the outer sleeve covers a join between the tubular body portion and the shoulder portion and/or the base portion.

21. (canceled)

22. A method of manufacturing a bottle, including the steps of: fabricating or providing a tubular main body formed in one piece by a spiral wound tube manufacturing process; joining an inner shoulder portion to one end of the tubular main body; joining an outer shoulder portion to the inner shoulder portion and/or the tubular main body; joining a base portion to the other end of the tubular main body.

23. (canceled)
